(19) United States
(12) Patent Application Publication
(10) Pub. No.: US 2022/0249986 A1
(43) Pub. Date: Aug. 11, 2022

(54) CARTRIDGE FILTRATION SYSTEM CONTAINED IN A FLEXIBLE BAG AND VACUUM CLEANER EQUIPPED WITH SUCH A SYSTEM

(71) Applicant: KOKIDO DEVELOPMENT LIMITED, Kowloon (HK)

(72) Inventors: JEAN BRUNEEL, KOWLOON (HK); MAX ROUMAGNAC, MARTIGNAS SUR JALLE (FR)

(21) Appl. No.: 17/669,300

(22) Filed: Feb. 10, 2022

(30) Foreign Application Priority Data
Feb. 11, 2021 (EP) 21156656.7

(51) Int. Cl. B01D 29/11; B01D 35/30; E04H 4/16

(52) U.S. Cl. CPC B01D 29/11; E04H 4/1654; E04H 4/1636; B01D 35/30

(57) ABSTRACT

A filtration system for a vacuum cleaner to clean swimming pools. The filtration system includes a filtration cartridge to filter fine debris and a watertight flexible bag to collect bulky debris. The filtration cartridge is attached inside the watertight flexible bag by at least one tubular sleeve. The sleeve passes through the flexible bag and gripping it against at least one end of the filtration cartridge in a watertight manner.

### TECHNICAL FIELD

The present invention belongs to the field of swimming pool maintenance devices and the like, in particular brushes and submersible vacuum cleaner robots, and relates more particularly to a cartridge filtration system contained in a flexible bag for vacuum cleaners for cleaning swimming pools and a vacuum cleaner equipped with such a system.

### PRIOR ART

Vacuum cleaners for swimming pools are known and widespread commercially in various forms. Whether it be a case of manual brushes or autonomous robots, the majority of these devices provide more or less effective cleaning according to the aspiration power allocated, but especially the filtration quality.

This is because, at the bottom of the swimming pool, either fine debris such as grains of sand and other particles or more bulky debris such as dead leaves accumulate overall. The filtration is not the same for each type of debris.

The applicant clearly explains this problem in the document EP3744927A1 at paragraph [0014] for example.

As a general rule, the fine particles are filtered by means of a conventional low-porosity bag. However, these bags have a fairly small filtering surface that quickly becomes clogged, and therefore requires frequent washing. This therefore has the effect of extending the swimming pool cleaning time.

To increase the filtering surface, filtering cartridges with pleated fabric can be used. Because of their numerous longitudinal pleats, these cartridges make it possible to obtain a fairly large filtering surface, to delay clogging and to increase the fineness of filtration, while having a compact cylindrical design and therefore a smaller size.

Such filtration cartridges are for example used in the venturi-effect vacuum cleaner brushes described in the documents FR2683845 and FR2715960.

These standard cartridges cannot however be mounted on just any vacuum cleaner brush and sometimes require adaptation means.

The document FR2683845 discloses an adaptor that can be manufactured in several models so that the container of the filtering cartridge is mounted on any vacuum cleaner brush.

In other solutions, such as the one in the document FR2715960, the container of the cartridge forms an integral part of the vacuum cleaner.

In both cases, the container of the cartridge is rigid and therefore has fixed dimensions that enable it to receive only one cartridge model of a given size. In addition, the internal volume defined by these rigid containers remains limited and does not enable leaves and other bulky debris to be properly collected.

The document U.S. Ser. No. 10/711,475 for its part describes a filter holder making it possible to mount a cartridge on a vacuum-cleaner brush in replacement for the conventional filter bags. This system for attaching the cartridge to the body of the brush—specific according to the size of the brush and the size of the cartridge—consists in assembling a plate (at the top) and a collar (at the bottom) connected by a plurality of threaded rods with nuts, in order to attach a cartridge with a large inside diameter to the body of the brush.

The attachment system of this solution is complex and involves a special cartridge. In addition, the loaded water enters inside the cartridge and is discharged over its entire periphery. The storage volume for the debris corresponds to the interior volume of the cartridge.

This solution has many drawbacks, in particular the obligation to use a cartridge (and therefore a specific attachment assembly) having a large inside diameter substantially equal to the diameter of the helix in order not to restrict the discharge cross section, which would create a back pressure and would reduce the aspirated flow rate, and in order to contain leaves. This type of cartridge with a large inside diameter is very bulky, which is detrimental to the manual movement of the brush, has a relatively high cost and is not available in the majority of specialised shops.

In addition, assembling and dismantling this cartridge for cleaning thereof are not very practical since it comprises threaded rods. In addition, such cleaning remains tricky because of the debris that comes to be interposed inside the cartridge.

It should also be noted that this system would not make it possible to use standard cartridges with an inside diameter of the order of 40 to 50 mm since, on the one hand, the small cross section of flow of the loaded water would restrict the flow rate of the vacuum cleaner, and on the other hand the limited internal surface would very quickly be covered with leaves.

### OBJECT OF THE INVENTION

The present invention aims to overcome the drawbacks of the prior art disclosed above and proposes a mixed filtration, combining both a cartridge and a watertight flexible bag, effective both for fine debris and for bulky debris, adapting to various types of vacuum cleaner and with simplified maintenance.

For this purpose, the object of the present invention is a filtration system for a vacuum cleaner for cleaning swimming pools, comprising at least one fine-debris filtration cartridge, remarkable in that it comprises a flexible bag made from watertight material, for collecting bulky debris, inside which each filtration cartridge is attached so that the interior of said cartridge communicates with at least one discharge opening provided in said bag.

According to one embodiment, the filtration system comprises a plate closing at least one filtration cartridge at one end, to prevent bulky debris from entering inside said cartridge, said cartridge being attached axially to the flexible bag.

According to another embodiment, at least one filtration cartridge is attached perpendicularly to the flexible bag.

Advantageously, each filtration cartridge is attached to the flexible bag by means of at least one tubular sleeve, said sleeve passing through the flexible bag and gripping the latter against one end of the filtration cartridge in a watertight manner.

Thus the various elements of the filtration system are removable and can be cleaned separately, and therefore more effectively, and replaced as required.

According to a particular embodiment, the filtration system furthermore comprises one lacunar central member per filtration cartridge, said member being inserted inside said cartridge and projecting therefrom by at least one threaded end, a tubular sleeve being screwed onto said end so as to press the flexible bag against a flange of the filtration cartridge.

According to one embodiment, each tubular sleeve has a different diameter at each of the ends thereof in order to adapt to various sizes of filtration cartridge.

Advantageously, the flexible bag is made from transparent material.

The flexible bag includes an opening able to be gripped around a part of the body of a vacuum cleaner.

Another object of the invention is a vacuum cleaner for swimming pools, of the brush or robot type, including a filtration system as presented, mounted on a suction head of the vacuum cleaner for example.

The fundamental concepts of the invention having been disclosed above in their most elementary form, other details and features will emerge more clearly from the reading of the following description and with regard to the accompanying drawings, giving by way of non-limitative example an embodiment of a cartridge filtration system and flexible bag according to the principles of the invention.

### BRIEF DESCRIPTION OF THE FIGURES

The figures are given purely by way of illustration for better understanding of the invention and do not limit the scope thereof. The various elements can be depicted schematically and are not necessarily to the same scale. In all the figures, the identical or equivalent elements bear the same numerical reference.

There are thus illustrated in:

FIG. 1: a partial perspective view of a vacuum cleaner equipped with a filtration system according to the invention;

FIG. 2A: a schematic view in cross section of a filtration system according to a first embodiment of the invention;

FIG. 2B: a schematic view in cross section of a filtration system according to a second embodiment of the invention;

FIG. 3: a perspective view of the filtration system according to the embodiment in FIG. 2B; and

FIG. 4: an exploded view of the mounting between the cartridge and the tubular sleeves of the filtration system in FIG. 3.

### DETAILED DESCRIPTION OF EMBODIMENTS

It should be noted that certain technical elements well known to a person skilled in the art are described here to avoid any insufficiency or ambiguity in an understanding of the present invention.

In the embodiment described below, reference is made to a filtration system comprising a cartridge contained in a flexible bag, intended mainly for a suction brush for cleaning swimming pools. This non-limitative example is given for better understanding of the invention and does not exclude the use of the filtration system on a suction robot for example.

In the remainder of the description, the term “cartridge” designates a filtration cartridge with a roughly cylindrical shape, the lateral walls of which provide a filtration of fine particles because of their low porosity, and the term “vacuum cleaner” designates by extension an apparatus for cleaning by suction, in this case for swimming pools.

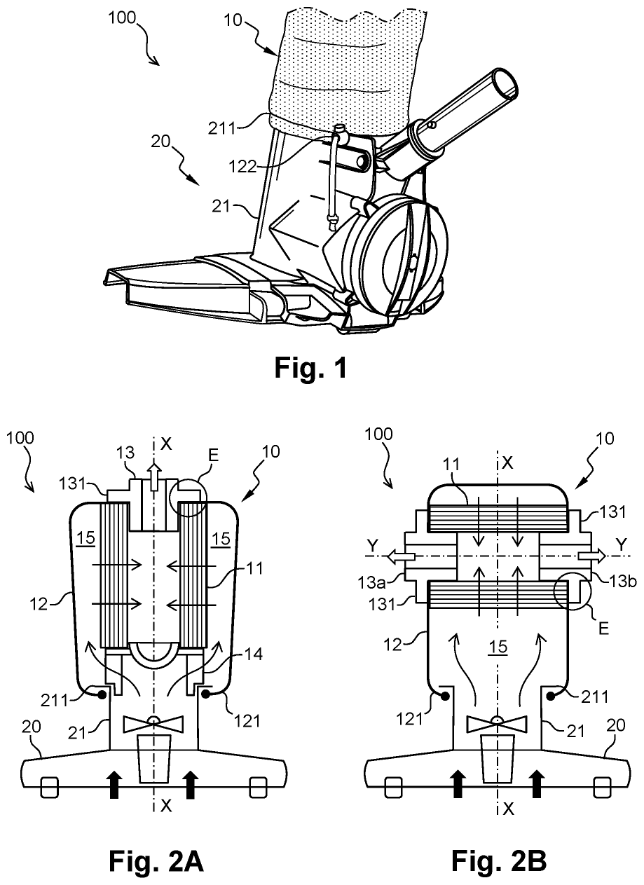

FIG. 1 shows partially a vacuum cleaner 100, of the brush type, equipped with a filtration system 10 mounted on a suction head 20 of the vacuum cleaner.

The filtration system 10 comprises a cartridge placed inside a flexible bag, the latter coming to be gripped on the suction head 20, and more precisely on a main pipe 21 thereof at a peripheral edge 211 of said pipe. Only the flexible bag is visible in FIG. 1, the latter showing an example embodiment wherein the bag is opaque.

FIGS. 2A and 2B show in more detail the filtration system 10 comprising a cartridge 11, a flexible bag 12 and at least one tubular sleeve 13 making it possible to grip the bag against the cartridge, said system being mounted on the suction head 20, the whole forming the vacuum cleaner 100, or at least the functional part thereof, according to two embodiments of the invention: a first embodiment with a cartridge attached vertically and a second embodiment with a cartridge attached horizontally.

The cartridge 11, according to the example illustrated, has a hollow cylindrical shape with a circular cross section, defining filtering lateral walls characterised by the thickness and porosity thereof. These filtering walls are adapted to the filtration of fine particles and may be of various types, preferably with pleated fabric so that the filtering surface of the cartridge is considerably increased.

The cartridge 11 is attached inside the flexible bag 12.

The flexible bag 12, according to the example illustrated, is formed from a watertight material, preferably elastic to adapt to cartridges of various sizes, both in length and in diameter. More preferably again, the flexible bag 12 has a default shape (relaxed) making it possible to define an internal volume 15 sufficient for both receiving the cartridge 11 and accumulating a given quantity of bulky debris (leaves). In other words, the internal volume 15 must correspond to a sufficient storage capacity for debris.

The elasticity of the flexible bag 12 is however not necessary provided that it has a volume adapted to the large-sized cartridges 11 that exist commercially.

The flexible bag 12 may be opaque or transparent, preferably transparent to enable the user to view its level of filling with bulky debris or the state of fouling of the cartridge before if necessary carrying out cleaning.

The flexible bag 12 fits onto the main pipe 21 of the suction head 20 by its bottom opening 121. In fact the bottom opening 121 is placed around the peripheral edge 211 of the pipe 21 and comprises clamping means adapted so as to ensure closure preventing the bulky debris collected from falling into the water of the swimming pool again.

The bottom opening 121 of the flexible bag 12 may therefore be elastic, through the presence of an annular elastic band concealed in the material constituting the bag for example, or simply include adapted clamping means such as a clamping bead 122 provided with a spring stop button shown in FIG. 1.

More generally, the flexible bag 12 can be attached to the body of the vacuum cleaner 100 in the same way as traditional filter bags without additional accessory.

The flexible bag 12 furthermore includes at least one discharge opening against which the cartridge 11 is positioned axially, and wherein the tubular sleeve 13 comes to be inserted to grip the bag against said cartridge.

The tubular sleeve 13, according to the example illustrated, is conformed so as to attach the cartridge 11 against the flexible bag 12 either by screwing or by elastic deformation, and makes it possible to discharge the filtered water. This is because the tubular sleeve 13 includes a through axial opening allowing discharge of the filtered water and an annular abutment surface 131 for pressing the flexible bag 12, or more precisely the peripheral edge of the discharge opening provided in said bag, against the end of the cartridge 11 so as to provide a seal E at this abutment surface.

The tubular sleeve 13 can be fixed to the cartridge 11 in various ways, inside or outside it, and with or without joining elements.

The tubular sleeve 13 may be reversible and have a different diameter at each of its ends to be able to adapt to two sizes of cartridge.

FIG. 2A shows the filtration system 10 mounted on the suction head 20 according to a first embodiment wherein the cartridge 11 is placed vertically, and therefore parallel to a longitudinal axis X of the suction head. Preferably, the axis X and the axis of the cartridge are substantially coincident.

In this configuration, the filtration system 10 includes a single tubular sleeve 13, disposed axially at the top of the flexible bag 12. Because of this the flexible bag comprises a single opening for discharging filtered water.

Nonetheless, and because of its axial position above the suction pipe 21, the filtration system 10 furthermore includes a support plate 14 provided with a central deflector for the aspirated flow and spaced-apart feet resting on the peripheral edge 211 of said pipe.

For example, the support plate 14 may have a roughly circular shape and include three feet arranged in a triangle so as to interfere as little as possible with the passage of the water aspirated towards the internal volume 15 of the flexible bag 12.

Thus, the aspirated dirty water (shown by black thick arrows) enters the suction system 10, passing laterally through the support plate 14, passing between the feet of the latter, before passing through the lateral walls of the cartridge 11, leaving the bulky debris (leaves) in the internal volume 15 of the bag 12, and finally emerging filtered through the axial opening of the tubular sleeve 13 (white thick arrow).

FIG. 2B shows the filtration system 10 mounted on the suction head 20 according to a second embodiment wherein the cartridge 11 is placed horizontally, and therefore perpendicularly to the longitudinal axis X of the suction head. In other words, the axis X is perpendicular to a longitudinal axis Y of the cartridge 11 and thereby of the tubular sleeves 13a and 13b.

In this configuration, the filtration system 10 includes two tubular sleeves 13a and 13b, one at each end of the cartridge 11. Because of this the flexible bag 12 has two lateral discharge openings, one on each side. The two sleeves 13a and 13b are preferably identical and attached in the same way.

Thus, the aspirated dirty water rises directly in the flexible bag 12, leaves therein the bulky debris and next passes through the lateral walls of the cartridge 11 in order to filter the fine particles before diverting laterally towards the discharge opening and emerging therefrom filtered.

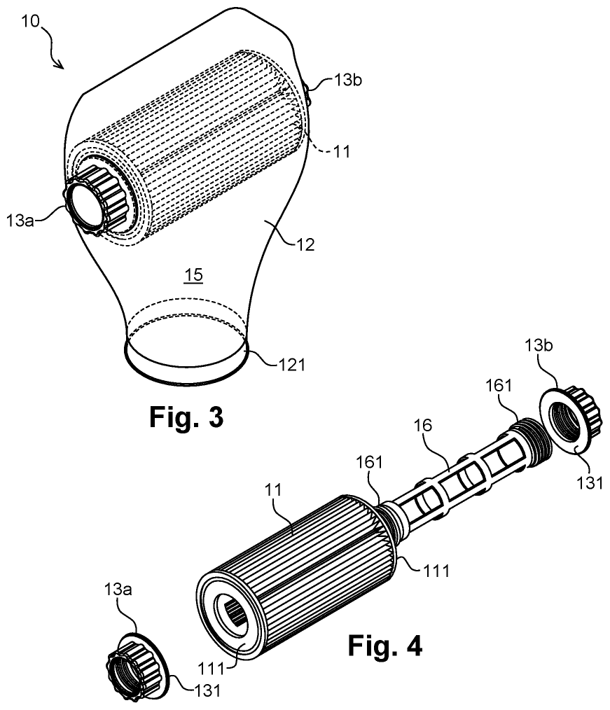

FIG. 3 shows the filtration system 10 according to this embodiment, wherein the cartridge 11 is placed horizontally in the flexible bag 12, held by two tubular sleeves 13a and 13b.

FIG. 4 shows the specific mounting between the cartridge 11 and the tubular sleeves 13a and 13b, corresponding to the embodiment in FIG. 3.

For this specific mounting, the filtration system furthermore comprises a cylindrical central member 16 lacunar in order not to interfere with the filtration, which is inserted inside the cartridge 11 and terminates in two threaded ends 161. These threaded ends 161 remain outside the cartridge 11, when the central member 16 is positioned therein, and each receive a tubular sleeve 13a and 13b by screwing until the annular abutment surfaces 131 come up against the flanges 111 of the cartridge. Naturally, the flexible bag 12 is then gripped between the annular abutment surfaces 131 of the tubular sleeves and the flanges 111 of the cartridge.

It is clear from the present description that some elements of the filtration system may be modified, replaced or omitted and that some adjustments may be made to the use of the system, without departing from the scope of the invention. For example, the filtration system may include two or more cartridges juxtaposed or superimposed inside the flexible bag with as many discharge openings in the bag as necessary.

1-9. (canceled)

10. A filtration system for a vacuum cleaner to clean swimming pools, comprising at least one filtration cartridge to filter fine debris and a flexible bag, made from a waterproof material, to collect bulky debris, each filtration cartridge is attached inside the flexible bag so that inside of said each filtration cartridge communicates with at least one discharge opening of the flexible bag.

11. The filtration system of claim 10, further comprising a plate closing said at least one filtration cartridge at one end, to prevent the bulky debris from entering inside said at least one filtration cartridge, and wherein said at least one filtration cartridge is attached axially to the flexible bag.

12. The filtration system of claim 10, wherein said at least one filtration cartridge is attached perpendicularly to the flexible bag.

13. The filtration system of claim 10, wherein said each filtration cartridge is attached to the flexible bag by at least one tubular sleeve, said at least one tubular sleeve passing through the flexible bag and gripping the flexible bag against one end of said each filtration cartridge in a watertight manner.

14. The filtration system of claim 13, further comprising one lacunar central member per said each filtration cartridge, the lacunar central member being inserted inside said each cartridge and projecting therefrom by at least one threaded end, said at least one tubular sleeve being screwed onto said one end of said each filtration cartridge so as to press the flexible bag against a flange of said each filtration cartridge.

15. The filtration system of claim 13, wherein each tubular sleeve has a different diameter at each end so as to be configurable to various sizes of said at least one filtration cartridge.

16. The filtration system of claim 10, wherein the flexible bag is made from a transparent material.

17. The filtration system of claim 10, wherein the flexible bag comprises an opening configured to be gripped around a part of a body of the vacuum cleaner.

18. A vacuum cleaner for swimming pools, of a brush or robot type, comprising the filtration system of claim 10.
